(19) United States
(12) Patent Application Publication
(10) Pub. No.: US 2008/0317907 A1
(43) Pub. Date: Dec. 25, 2008

(54) Method and apparatus for applying aqueous coating to cooked foods

(76) Inventors: Jennifer Kay Thomas, Denville, NJ (US); Robert Sauer, Sparta, NJ (US); Melody Yuen, Edison, NJ (US); Justin Kukura, Blakeslee, PA (US); Steve Weiner, Easton, PA (US); Francois Errandonea, Hopatcong, NJ (US); Burnitta B. Johnson, East Rutherford, NJ (US); Patricia Ann Mozeke, Bedminster, NJ (US)

Correspondence Address: GREENBLUM & BERNSTEIN, P.L.C., 1950 ROLAND CLARKE PLACE, RESTON, VA, 20191, US

(21) Appl. No.: 11/820,228

(22) Filed: Jun. 19, 2007

(51) Int. Cl. A23G 3/02; A23G 3/32; A23G 3/34

(52) U.S. Cl. 426/93; 426/273; 99/355

(57) ABSTRACT

A cooked snack food or cooked edible core material, such as roasted nuts, or baked snack chips, while still hot from the cooking step, is tumbled and sprayed with an aqueous solution of a water-soluble, film-forming coating component, such as a maltodextrin. The tumbling and spraying is performed immediately after cooking so that latent heat from the cooked edible core material, reduces the moisture content of the applied aqueous solution to form a dry, thin film coating of the coating component on the edible core material. The need for a separate, subsequent drying step or forced air drying equipment to reduce the moisture content is eliminated by evaporative cooling of the hot cooked snacks and flashing of the applied aqueous coating solution. The dry, coated cooked snack may be cooled to obtain a snack food having a thin, uniform coating which enhances appearance, texture, taste and shelf life.

### FIELD OF THE INVENTION

The present invention relates to the production of coated food products, such as coated baked or fried snacks having an edible cooked core, such as oil roasted nuts, which are coated with a water soluble film-forming coating component.

### BACKGROUND OF THE INVENTION

Coatings are applied to foods to enhance one or more attributes of appearance, taste, texture, and shelf-life. To facilitate production of an even coating, particularly thin coatings or films, a coating composition is applied in a liquid state, such as a melt, or dissolved or suspended in an edible carrier liquid such as water. Generally, the lower the viscosity of the liquid, the easier it is to apply evenly to an edible substrate. However, for molten coatings, such as melted sugar coatings, high coating temperatures are generally needed to achieve low viscosities, and such high temperatures may adversely affect the taste, appearance, or texture of the edible substrate, or even the coating itself. Also, use of a molten coating component or a viscous liquid coating composition may result in stickiness problems and agglomeration of individual coated substrates. Also, use of an aqueous coating composition generally requires substantial removal of water or moisture from the coated edible substrate to set the coating component and to avoid adverse of effects of the added moisture on the texture and shelf-life of the coated product. It is widely known that reducing the moisture of nuts that have been coated with an aqueous solution is necessary to preserve the texture and shelf life of the nut. Use of a separate drying step after coating an edible product is particularly important when the aqueous coating is applied to an already cooked substrate where further application of heat would otherwise be unnecessary. However, use of a separate drying step requires additional equipment and energy and may adversely affect flavor, appearance, and texture of the final coated food product.

For example, U.S. Pat. No. 5,424,085 and International Patent Publication No. WO 95/12990, published May 18, 1995, each to Hsieh et al disclose production of coated nuts or seeds using a sugar coating composition having a very low moisture content which must be heated to very high coating temperatures. In the Hsieh et al process roasted or unroasted nuts or seeds are admixed at a temperature ranging from 180° F. to 280° F. with coating syrup at a temperature ranging from 270° F. to 330° F. Prior to coating, the roasted nuts are permitted to cool on a cooling table or are cooled using mechanical means to a temperature ranging from 180° F. to 280° F. The coating syrup consists essentially of sugar and of sweetener syrup in weight ratio (dry basis) ranging from 1.7:1 to 3.5:1, and from 1 to 5% by weight (on a total coating syrup basis) of water. Shear mixing is imparted to the admixture to distribute the coating syrup over at least a majority of the nuts or seeds. Cooling gas or other cooling means are applied to the admixture while continuing shear mixing until the coating syrup begins to set. Use of coating syrup temperatures below 270° F., it is disclosed, can result in a sticky or tacky coating which sticks to teeth and gums during eating and poor stability against increase in stickiness and staling, especially on storage under high temperature and relative humidity conditions.

As disclosed in U.S. Patent Publication No. 2005/0214414 and European Patent Application Publication No. EP 1,550,378 A1 each to Miranda et al coating solution is applied to a roasted nut or dried fruit and then dried in the same rotary drum where the coating solution is applied, by means of a blower, which facilitates evaporation, as well as the transfer of water vapor and heat by convection. Alternatively or additionally, the drying may be performed using a drying tunnel, air-conditioned chamber, oven or kiln when the drying in the rotary drum is not sufficient to dry the coating solution. In some cases the drying may be done in a drying tunnel having separate areas for drying with hot air, drying with an infra-red lamp, and cooling with cold air. The coating solution may be a filmogenic solution of a cellulose ether selected from hydroxypropylmethyl-cellulose, hydroxypropylcellulose, methylcellulose, carboxymethylcellulose, and ethylmethylcellulose, acacia gum, maltodextrin, an edible lipid or a combination of various edible lipids, and their mixtures. The drying of the filmogenic solution deposited on the nut is done with air, at a temperature equal to or lower than 110° C., and in some cases it may be necessary to achieve higher temperatures, of up to 200° C.

U.S. Patent Publication No. 2005/0260308 to Engels et al discloses the application of seasoning to a food product by transporting the product at a temperature of 90° C. via a belt to a tumbler, and spraying a dispersion of fat and flavor on the food product while keeping the temperature at 90° C. Subsequently, a coating composition containing maltodextrin, icing sugar, and salt in water is added to the same tumbler and is sprayed on the coated food product. Finally, the coated food product is dried in the tumbler for about 5 minutes followed thereafter by a further drying step in a second tumbler until a moisture content of 1% is obtained.

U.S. Pat. No. 5,149,562 to Hebert et al discloses first oil roasting raw nuts and then coating the roasted nuts with an edible aqueous protein solution. The protein-coated nuts are then coated with a seasoning mix. In a particular embodiment, the roasted nuts emerging from the roasting zone remain on a wire mesh conveyor belt, while the latter is still in motion, for a short period of time, advantageously about 0.5 to about 2.0 minutes, to allow excess oil to drain from the nuts prior to the point at which the nuts are discharged onto the continuous belt conveyor for transfer to a coating zone. In an optional, but desirable, additional stage of the process, the continuous flow of roasted nuts emerging from the roasting zone is then discharged onto a continuous belt conveyor or like conveying means and transferred to a cooling zone in which the temperature of the nuts is reduced rapidly, illustratively within a period of about 5 minutes and preferably less than about 2 minutes, to a temperature below about 100° F. This operation serves to ensure that excessive roasting of the nuts, because of maintenance of the higher temperatures at which the nuts emerge from the previous step, does not occur. This latter zone advantageously comprises a closed or partially closed area through which air or inert gas, at temperatures of about 100.degree. F. or less, is caused to flow at a rate sufficient to achieve the desired reduction in temperature of the nuts. The efficiency of this cooling step is greatly enhanced by transporting the nuts through the cooling zone on a conveyor belt which is perforated to permit passage therethrough of cooling air or inert gas. The nuts are agitated by a horizontal mechanical mixer as they are being transferred from the roasting zone to the cooling zone or within the cooling zone. This operation is designed to effect separation or singularization of the individual nuts. In the next step of this process, the roasted nuts and the edible protein, are conveyed by appropriate means from storage facilities and are introduced continuously and in the desired proportions to a coating zone. The coating zone comprises any mechanical continuous coating means commonly employed in the coating art, such as a revolving coating drum. The nuts are coated with one or more protein coating solutions followed by a particulate seasoning coating. When the nuts are coated with a protein solution, they may have excess moisture on them after coating. In such situations, it is disclosed, it may be desired to dry the nuts, for instance, at temperatures between about 100° F. and 150° F. to remove the excess moisture prior to packaging.

To eliminate the need for a drying process, coating solution can also be applied prior to oil roasting, as in U.S. Pat. Nos. 4,501,758, 4,738,865, and 4,981,707 each to Morris, and U.S. Pat. No. 4,910,028 to Bernacchi et al. As disclosed therein, a honey flavoring-coated, oil roasted nut is produced by applying an aqueous food-grade adhesive comprising a dextrin, such as maltodextrin and applying a flavoring composition thereto, and then drying the adhesive-coated comestible until its surface is substantially dry to the touch, prior to oil roasting thereof.

A process for applying breadcrumbs to nuts is disclosed in European Patent Application Publication No. EP 0841012 A1 to Zwiekhorst, published May 5, 1998. A paste layer of flour is applied to the nuts by means of spraying liquid, an adhesive layer is applied, and then breadcrumbs are applied. The coated products may then be fried or roasted in hot air.

U.S. Pat. No. 3,787,588 to Turitz discloses preparing a snack food by wrapping a nut with a thin shell of a dough comprising a mixture of 85-35% by volume wheat flour and 15-65% by volume corn flour so that the dough contacts the skin of the nut and then baking or frying the dough wrapped nut. The dough, it is disclosed, forms a hard, crunchy, crisp crust.

U.S. Pat. No. 5,188,855 discloses coating of an expanded snack, such as a cheese ball, with a batter and bread crumbs, and then baking and frying it.

The production of snack products with an expanded coating on a comestible, such as nuts, is disclosed in U.S. Pat. No. 4,053,650 to Chino et al, U.S. Pat. No. 4,499,113 to Mochizuki et al, U.S. Pat. No. 5,433,961 to Lanner et al, U.S. Pat. No. 5,571,546 to Kristinus et al, PCT International Patent Publication No. WO 99/34691 to Kreuning et al, and U.S. Patent Application Publication No. 2004/0067282 A1 to Karwowski et al . In these processes, frying or baking is performed after the coating is applied to the comestible.

In the process of PCT International Patent Publication No. WO 99/34691 a batter resembling pancake batter containing water, wheat flour, and possibly other starches or flours is used to coat nuts. One or more particles are provided on the layer which is still wet so that a part of the particles projects from the coating layer, and then the coated product is deep fried. For obtaining a highly expandable dough material, it is disclosed, a pregelatinized waxy maize flour, native waxy maize flour, and pregelatinized sticky rice flour may be employed. However, use of a batter to the coat nuts tends to result in agglomeration or sticking of individual nuts to each other, and non-uniform coating of the nuts.

U.S. Pat. No. 4,053,650 to Chino et al discloses the production of puffed confections in which leguminous seeds, nuts or other food particles are incorporated which have a uniform shape. The food particles are coated in a revolving pan alternately with an edible flour composition and an aqueous solution of a sugar, syrup or gum. The flour composition contains a self non-expandable cereal flour or starch such as wheat flour or rice flour or a starch such as potato starch or corn starch, and a self-expandable cereal flours or starches such as alpha-waxy maize starch or alpha-waxy rice flour. The coated pieces are baked in a mold, and an open space is created within the baked shell so that the piece is moveable within it. The moisture content of the coated layer must be no more than 23% when the articles are baked because the expansion strength of the flour composition and the excessive pressure of the steam vapor force the steam and gelatinized paste compositions of the coated layer out of the mold.

U.S. Pat. No. 4,499,113 to Mochizuki et al discloses that “Onorokemame” is a Japanese snack product conventionally made from a formulation that contains mainly wheat flour and a large amount of expandable pregelatinized starchy flour such as pregelatinized waxy corn flour or pregelatinized glutinous rice flour that expands with heat to provide a fully expanded product. According to Mochizuki et al the conventional product does not possess full savor because a starchy flour which is less expandable but provides good savor, such as mashed potato flour and corn flour is not employed. In the process of Mochizuki et al, coating a core material with a layer of starchy flour that has a single degree of expandability as in the conventional product, results in difficulty in controlling the expansion of the coating during heating and difficulty in attaining a suitable degree of hardness. In the Mochizuki et al process and composition, an expanded coating is obtained with a starchy flour formulation that contains a smaller amount of highly expandable pregelatinized starchy flour, such as pregelatinized waxy corn flour and pregelatinized glutinous rice flour, and 50 to 77.5% by weight, based on the total starchy flour, of less expandable starchy flour such as mashed potato flour and corn flour. The starchy flour formulation is applied using two coatings, each coating comprising a mixture of two different types of starchy flour. The second coating is less expandable than the first coating.

Use of a second coating which is less expandable than a first coating is also disclosed in U.S. Pat. No. 5,571,546 to Kristinus et al. Kristinus et al discloses food products having a comestible core, such as nuts, surrounded by coating compositions containing a mixture of linear and branched polysaccharides. The polysaccharide mixture is provided by a mixture of waxy and non-waxy starches. A major proportion of non-pregelatinized waxy starch is employed in a first layer to obtain an expanded or puffed layer having a flaky texture. A second layer which comprises a major proportion of a non-waxy starch, such as wheat flour, provides a hard, protective outer shell. Use of a pregelatinized waxy starch in place of the non-pregelatinized waxy starch, it is disclosed, would not result in the desired flaky texture.

U.S. Pat. No. 5,433,961 to Lanner et al discloses the continuous production of non-aggregated edible cores, such as nuts, with crisp farinaceous coatings. A farinaceous powder is continuously dusted on the dry zone of a tumbling bed of edible cores. As the edible cores repeatedly rotate through both the wet and dry zones, they are repeatedly coated by the farinaceous powder in the dry zone and hydrating liquid in the wet zone thereby forming farinaceous dough around the individual edible cores. The farinaceous powder contains flour, preferably from about 20 to 100%, more preferably from about 35 to 95% by weight of flour. The farinaceous powder further comprises from about 0 to 50%, more preferably from about 5 to 40% by weight of pregelatinized starch. The pregelatinized starch is preferably a pregelatinized modified waxy starch. Flours which may be used in the dusting step include nut flour and cereal grain flours derived from wheat, rice, oats, corn, barley, rye or mixtures thereof. The farinaceous dough coating formed on the individual edible cores, it is disclosed, must contain a flour and starch to sugar weight ratio of from about 0.5:1 to 30:1, preferably from about 1.5:1 to 10:1 to obtain a crisp texture of the coated snack product.

U.S. Patent Application Publication No. 2004/0067282 A1 to Karwowski et al discloses using a highly expandable, pregelatinized waxy starch and a raw potato starch to obtain a snack having an expanded, crispy, chip-like textured coating which contains a substantial amount of wheat flour. Thick, uniformly expanded, cellular coatings having a crispy, chip-like texture are achieved in a single, homogeneous coating or layer and without the need for a baking mold. An expandable, adherent, dough coating is formed on an edible core material, such as a nut or dried fruit, without substantial or any agglomeration or sticking of individually coated core material pieces to each other. The dough coating may be expanded by frying or baking to obtain savory or sweet snack products having a substantially expanded, crispy, chip-like coating or casing.

The production of snack products having a non-expanded coating for imparting a crunchy or crispy texture to a comestible is disclosed in U.S. Pat. No. 4,913,919 to Cornwell et al, U.S. Pat. No. 5,362,505 to Hsieh et al, and International Patent Publication No. WO 98/00038 to McDonald et al. A high solids, aqueous coating composition having from 10% to 40% by weight maltodextrin and from 10% to 40% by weight starch granules is employed to modify the texture, flavor and/or color of comestible products such as cookies, corn chips, potato chips, and puffed corn snacks in the process of U.S. Pat. No. 4,913,919.

In the process of U.S. Pat. No. 5,362,505 individual, crunch-confectionery-coated edible nuts are produced by first coating unblanched, raw nuts with a film-forming polysaccharide to maintain the skins adhered to the nuts in a durable polysaccharide coating. The coated nuts are then coated in a pan coater with a sucrose syrup, followed by heating to remove moisture and to thereby form a crystalline coating. The crystalline coating is then partially melted to form a crystalline-amorphous coating on top of the polysaccharide coating on the individual nuts.

U.S. Pat. No. 6,352,730 to Zimmerman et al and International Patent Publication No. WO 98/00038 to McDonald et al disclose application of a vitamin suspension to the surface of a fried snack, such as potato chips, soon after emerging from the fryer. The encapsulated or powdered vitamins are suspended in a flowable edible fat.

The present invention provides a process and apparatus for the application of an aqueous solution of a film-forming coating component to a cooked snack food such as roasted nuts to enhance appearance, taste, texture, and shelf-life of the snack food without the need for drying the coating in a separate drying step with forced air, or convective heat transfer from the air to the coating. Stickiness problems and agglomeration of individual coated substrates, and overcooking or burning of the substrate and the coating component are substantially or completely avoided in the method of the present invention while achieving thin, uniform, crispy coatings of non-expanded water-soluble film-forming carbohydrates, such as maltodextrins and other polysaccharides, and proteins.

### SUMMARY OF THE INVENTION

A cooked snack food, such as roasted nuts, is coated with an aqueous coating solution to obtain a thin, uniform coating which enhances appearance, texture, taste and shelf life of the snack food without the need for a separate drying step to reduce moisture. In accordance with the present invention, conductive heat transfer from the cooked substrate to the aqueous coating, rather than convective heat transfer to the aqueous coating from air supplied by forced air drying equipment is employed to substantially reduce coating moisture and set the coating into a crispy, thin film with a glazed or matted appearance.

An edible core material is cooked, such as by frying or roasting, or baking, to obtain a cooked edible core material, and while still hot from the cooking step, the cooked core material is tumbled and sprayed with an aqueous solution comprising a water-soluble, film-forming coating component. The aqueous solution is sprayed onto the cooked edible core material while tumbling the edible core material to coat the edible core material with the aqueous solution. The tumbling and spraying is performed immediately after cooking of the edible core material so that latent heat from the cooked edible core material flashes off moisture from the aqueous solution to reduce the moisture content of the aqueous solution on the edible core material and form a dry coating of the coating component on the edible core material. Generally, the spraying may be performed within about 10 minutes, for example within about 3 minutes, preferably within about 60 seconds, most preferably within about 30 seconds after the cooked product leaves the cooking apparatus, such as a roasting apparatus or fryer in the case of roasted nuts. The dry, coated edible core material may then be cooled to obtain a coated food product.

At the time of application of the aqueous coating solution to the edible core material, the cooked core material is at a temperature above the boiling point of the aqueous coating solution, for example at a temperature of from about 215° F. to about 400° F., preferably from about 250° F. to about 350° F. Also, at the time of application the cooked core material may have a moisture content of less than about 10% by weight, for example from about 0.25% by weight to about 7% by weight, preferably from about 1% by weight to about 5% by weight, based upon the weight of the cooked core material, such as a roasted nut. The aqueous coating solution which is applied to the core material may be at any temperature, for example at room temperature or above, preferably at an elevated temperature, for example at least about 150° F., but which is below the boiling point of the aqueous coating solution. For example, in embodiments of the invention, the aqueous coating solution may be applied at a temperature of from about 160° F. to about 212° F.

In embodiments of the present invention, the film-forming coating component may be one or more film-forming carbohydrates and proteins, preferably at least one polysaccharide, such as one or more film-forming water soluble starch, corn syrup solids, maltodextrins, and cellulose derivatives, most preferably a maltodextrin.

The moisture content of the aqueous solution which is sprayed onto the tumbling edible core material may be sufficient to provide a relatively low viscosity for spray atomization and for achieving a uniform, thin coating. However, the moisture content should not be so high that the latent heat from the cooked edible cores, such as roasted nuts can not sufficiently reduce the moisture content of the aqueous coating to dry and set the film-forming component. In embodiments of the invention, the moisture content of the sprayable aqueous solution may be from about 25% by weight to about 75% by weight, preferably from about 40% by weight to about 60% by weight, based upon the weight of the aqueous solution, and the latent heat from the cooked edible core material reduces the moisture content of the aqueous solution so as to obtain a coated food product having a moisture content of less than about 10% by weight, for example from about 0.5% by weight to about 8% by weight, preferably from about 2% by weight to about 5% by weight, based upon the total weight of the edible core and the dried coating. In embodiments of the invention, the coating step may result in a moisture gain of less than about 2% by weight, preferably less than about 1% by weight, most preferably less than about 0.5% by weight, as compared to the cooked product prior to application of the aqueous coating solution.

In embodiments of the invention, the aqueous coating solution may contain a film-forming coating component, such as a maltodextrin, in an amount of from about 25% by weight to about 75% by weight, preferably from 40% by weight to about 60% by weight, based upon the weight of the aqueous solution which is sprayed onto the tumbling edible core material. In the coated products of the present invention, the coating component content on the edible core material may be from about 0.5% by weight to about 20% by weight, preferably from about 1% by weight to about 5% by weight, based upon the total weight of the edible core and the dried coating.

The aqueous coating solution may further include at least one process compatible ingredient such as flavors, colors, fats, oils, shortenings, emulsifiers, sugars, salt, vitamins, minerals, antioxidants, and mixtures thereof, preferably salt and an antioxidant.

Apparatus for the continuous production of coated products, such as coated nuts in accordance with the present invention may include a cooking apparatus such as an oil roster or fryer for oil roasting nuts, and a continuous rotary tumbler for continuously receiving and tumbling the cooked product, such as roasted nuts from an oil roaster. The rotary tumbler may be equipped with spraying apparatus for continuously spraying the cooked substrates or edible core materials, such as roasted nuts, as they are tumbled in the rotary tumbler. The spraying apparatus may include one or more nozzles arranged within the rotary tumbler for spraying an aqueous solution comprising a film-forming coating component to coat the tumbling cores, such as nuts with the aqueous solution. The rotary tumbler and the cooker, such as an oil roaster for nuts may be arranged so that the tumbling and spraying are performed immediately after the cooked edible cores, such as roasted nuts, exit the cooker, such as an oil roaster so that latent heat from the still hot cooked cores, such as freshly roasted nuts, flashes off moisture from the aqueous solution to reduce the moisture content of the aqueous solution on the roasted, tumbling cores and form a dry coating of the coating component on the cooked cores such as roasted nuts. The apparatus of the present invention also includes a cooling device for cooling the dry, coated cooked cores, such as coated, roasted nuts exiting from the rotary tumbler.

In preferred embodiments, the apparatus for the continuous production of coated products such as nuts may include a cooker, such as an oil roaster or fryer, and a rotary tumbler which are arranged so that the cooked product, such as roasted nuts are gravity fed directly from the cooker, such as a roaster to the rotary tumbler. The spraying apparatus preferably includes atomization nozzles for atomizing the aqueous solution in the rotary tumbler, and the cooling device preferably comprises a meshed conveying belt and a blower for blowing cool air across the belt.

### BRIEF DESCRIPTION OF THE DRAWINGS

The present invention is further illustrated by the accompanying drawings wherein:

FIG. 1 schematically shows a method and apparatus for coating roasted nuts according to the present invention.

FIG. 2 schematically shows a method and apparatus for coating baked snacks according to the present invention.

### DETAILED DESCRIPTION OF THE INVENTION

The coated snacks of the present invention are produced by the immediate, post-cooking application of a solution of a water-soluble film-forming coating component to a snack so that the latent heat of the cooked snack flashes off the water of the coating solution to set the film-forming coating component into a film which covers or encapsulates the snack. The rapid application of the coating solution to the cooked snack avoids the need for a separate drying step with forced air, and locks in freshness. In addition, the coating process of the present invention enhances taste, texture, appearance and texture of cooked snacks. The coated snacks include savory and sweet products. The coated snacks of the present invention exhibit enhanced flavors and taste, such as sweetness or fresh roasted flavor notes or fresh nut taste, a crispy or crunchy texture, good color and gloss, and very low rancidity as measured by hexanal values even after prolonged shelf-stable storage times.

The coating is generally a non-expanded or substantially non-expanded coating having a substantially uniform appearance or structure. The coating is desirably a continuous or at least substantially continuous coating which preferably completely encapsulates the cooked snack or edible core material. The outer surfaces of the snack coating are generally smooth with no blisters or bubbles formed on the outer surfaces of the coating and no large air pockets or bubbles present below the outer surface of the snack, within the coating layer. The thin coating of the present invention may be transparent or translucent and may exhibit a desirable glossy or semi-glossy appearance, or a matted appearance. In embodiments of the invention, the thickness of the non-expanded, at least substantially homogeneous coating may be less than about 1 mm. The weight of the non-expanded, crispy, crunchy coating may be from about 0.5% by weight to about 20% by weight, preferably from about 1% by weight to about 5% by weight, based upon the total weight of the edible core and the dried coating.

The cooked snacks or products which may be coated in accordance with the present invention may be any particulate product that is cooked long enough and at high enough temperatures so that immediately or shortly after cooking, the cooked product's latent heat resulting from the cooking is sufficiently high to substantially evaporate, flash-off, or reduce the moisture content of the aqueous solution of the film-forming coating solution to set or precipitate the film-forming component into a dry film without the need for additional drying by convection or forced air. The cooked snacks or edible cores include fried, oil roasted, dry roasted, baked, microwaved, extrusion cooked, dried or dehydrated snacks which are cooked in conventional manner using conventional cooking apparatus. For example, oil roasted nuts may be cooked in a conventional oil roaster or fryer using conventional nut oil roasting temperatures and times, and then the oil roasted nuts, while still hot from the roasting step may be coated with an aqueous solution of a film-forming coating component in accordance with the present invention. Cottonseed oil is a preferred roasting oil for use in the present invention. Also, in another embodiment, baked goods, such as crackers and cookies may be obtained by baking dough pieces in a conventional, continuous multi-zone oven using conventional baking temperatures and times, and then the resulting baked products, while still hot from the baking step may be coated with an aqueous solution of a film-forming coating component in accordance with the present invention.

A coated food product, such as a savory or sweet snack may be produced by cooking an edible core material to obtain a cooked edible core material, tumbling the cooked edible core material, and spraying an aqueous solution which contains a solubilized water-soluble, film-forming coating component onto the cooked edible core material while tumbling the edible cooked core material to coat the edible core material with the aqueous solution. The tumbling and spraying are performed immediately after cooking of the edible core material so that latent heat from the cooked edible core material flashes off moisture from the aqueous solution. The flashing caused by the latent heat from the cooking step reduces the moisture content of the aqueous solution on the edible core material and forms a dry coating of the coating component on the edible core material and cooling the dry, coated edible core material. The dried, coated core material may then be cooled to obtain individual pieces having a core material coated, encapsulated, or encased in a thin coating which has a crispy or crunchy texture. In the present invention, a substantially uniform coating on individual core material pieces is achieved without substantial agglomeration or sticking of pieces to each other during coating and during subsequent processing steps as cooling, and seasoning application.

Edible core materials which may be coated in accordance with the present invention include nuts, whole grains, seeds, beans, dried fruits, such as raisins, dried cherries, dried cranberries, and dried pineapple, dried vegetables and legumes such as green peas, corn nuts, cookies, crackers, ready-to-eat cereals, food bars such as nutritional or protein bars, confectionary chips, such as fried or baked potato chips and corn chips, and pretzels, and particulates thereof and agglomerates thereof. Preferred edible core materials are nuts, such as peanuts, macadamia nuts, almonds, cashews, Brazil nuts, filberts, pecans, and walnuts. The nuts may be blanched, unblanched, or shelled nuts, seasoned or flavored nuts such as smoked almonds, flavored peanuts, dry-roasted nuts, and seasoned corn nuts. The most preferred edible core material is almonds. The nuts which are subjected to the coating of the present invention may be oil roasted, dry roasted, or honey roasted. Most preferably, oil roasted nuts are employed in the present invention. In preferred embodiments, each coated snack piece contains only a single or individual nut or other edible core piece.

In accordance with the present invention, a uniform, thin, continuous coating is achieved with the use of a water-soluble, film-forming coating component. The film forming component may be water soluble at room temperature or temperatures up to about the boiling point of water. However, film-forming components which are highly soluble at temperatures of less than about 180° F., are generally preferred for the facilitation of forming lower viscosity, sprayable, atomizable water solutions with less tendency for premature precipitation of the film forming component. The use of lower viscosity coating solutions helps to form more uniform films and thinner films, and helps to avoid inter-particle stickiness problems, and avoid spray nozzle clogging.

In embodiments of the present invention, the film-forming coating component may be one or more film-forming carbohydrates and/or proteins, preferably at least one polysaccharide, such as one or more film-forming water soluble starch, such as water soluble film-forming modified starches and film-forming pregelatinized starches, hydrolyzed starches such as corn syrup solids, dextrins and maltodextrins, cellulose derivatives, and vegetable gums. Examples of water soluble film-forming starches which may be used are film-forming modified high amylose corn starches, film-forming cold water soluble, modified waxy starches, and pregelatinized potato starches. Exemplary of cellulose derivatives which may be employed are cellulose ethers such as methyl cellulose, ethylmethyl cellulose, carboxymethyl cellulose, hydroxypropyl cellulose, and hydroxypropylmethyl cellulose. Water soluble gums which may be used include acacia gum and gum arabic. Water soluble film-forming proteins which may employed include animal and vegetable proteins, such as zein, albumin, soybean proteins, modified soybean proteins, and gelatin.

In embodiments of the present invention, water soluble film forming starch hydrolysates which may be used in present invention may have a dextrose equivalent (DE) of about 5 to 42, preferably from about 10 to about 30. Exemplary starch hydrolysates which may be employed are maltodextrins, corn syrup solids, and mixtures thereof. Preferred starch hydrolysates for use in the present invention are maltodextrins. They are generally readily soluble in water at low temperatures, form thin uniform films, generally provide clear or translucent films, and may contribute a desirable slight sweet taste to the final product. A maltodextrin is a nutritive saccharide polymer that consists of D-glucose units linked primarily by alpha-1-4 bonds and that has a DE of less than 20. A particularly preferred hydrolyzed starch is maltodextrin with a DE of less than or equal to about 10. In embodiments of the invention, a resistant maltodextrin, digestion resistant maltodextrin, or maltodextrin (soluble dietary fiber) may be employed alone or in combination with a conventional maltodextrin or other film-forming coating components. An example of a digestion resistant maltodextrin which may be employed is Fibersol®-2, a soluble dietary fiber (90% min. dsb) produced by Matsutani America, Inc. Fibersol®-2 is produced from corn starch by pyrolysis and subsequent enzymatic treatment (similar to the process to manufacture conventional maltodextrins) to purposefully convert a portion of the normal alpha-1,4 glucose linkages to random 1,2-, 1,3-, and 1,4-alpha or beta linkages. The human digestive system effectively digests only alpha 1,4-linkages; therefore the other linkages render the molecules resistant to digestion. An advantage of using a digestion resistant maltodextrin is that it increases the soluble dietary fiber content of the coated food product of the present invention.

The viscosity and solubility of maltodextrins in water vary with DE values. For example, the viscosity of maltodextrin solutions which may be employed in the present invention may be as shown in Table 1 wherein viscosity is in centipoises at 37.8° C. (100° F.):

TABLE 1
Viscosity of Maltodextrin Solutions as Function of DE and Concentration

| Concentration | 10-15 DE Maltodextrin | 15-20 DE Maltodextrin |
|---|---|---|
| (% by weight) | Viscosity (cp) | Viscosity (cp) |
| 50 | 125 | 12.5 |
| 60 | 1,125 | 125 |
| 70 | 20,000 | 2,000 |

The solubility values for maltodextrins in water at 20° C. as a function of DE values is shown in Table 2:

TABLE 2
Solubility of Maltodextrins in Water at 20° C. as a Function of DE

| DE Range | Solubility, % by weight |
|---|---|
| 9-12 | 40 |
| 13-17 | 60 |
| 17-20 | 70 |

In the present invention, the aqueous solutions which are employed are at elevated temperatures, so for a given DE value, the viscosity will be lower and the solubility will be higher than the values shown in Tables 1 and 2.

The moisture content of the aqueous solution of the film-forming component which is sprayed onto the tumbling edible core material may be sufficiently high to provide a relatively low viscosity for spray atomization and for achieving a uniform, thin coating. However, the moisture content should not be so high, and the water soluble film-forming component content should not be so low that the latent heat from the cooked edible cores, such as roasted nuts cannot sufficiently reduce the moisture content of the aqueous coating to dry and set the film-forming component. In embodiments of the invention, the moisture content of the sprayable aqueous solution may be from about 25% by weight to about 75% by weight, preferably from about 40% by weight to about 60% by weight, based upon the weight of the aqueous solution. The latent heat from the cooked edible core material reduces the moisture content of the aqueous solution so as to obtain a coated food product having a microbially shelf-stable moisture content of less than about 10% by weight, for example from about 0.5% by weight to about 8% by weight, preferably from about 2% by weight to about 5% by weight, based upon the total weight of the edible core and the dried coating. In embodiments of the invention, the coating step may result in a moisture gain of less than about 2% by weight, preferably less than about 1% by weight, most preferably less than about 0.5% by weight, as compared to the cooked product prior to application of the aqueous coating solution. For example, an oil roasted nut prior to application of the aqueous coating solution may have a moisture content of about 1.95% by weight, based upon the weight of the roasted nut. After the coating step, the coated nut leaving the coating drum, may have a moisture content of about 2.5% by weight, based upon the weight of the coated roasted nut, for a moisture gain of about 0.55% by weight.

In embodiments of the invention, the aqueous coating solution may contain a film-forming coating component, such as a maltodextrin, in an amount of from about 25% by weight to about 75% by weight, preferably from 40% by weight to about 60% by weight, based upon the weight of the aqueous solution which is sprayed onto the tumbling edible core material.

Generally, to avoid stickiness problems and waste, the coating solution which is sprayed onto the tumbling cores should be supplied in an amount which is just enough to provide coated products with a coating component content on the edible core material of from about 0.5% by weight to about 20% by weight, preferably from about 1% by weight to about 5% by weight, based upon the total weight of the edible core and the dried coating.

In embodiments of the invention, the aqueous coating solution may further include at least one process compatible ingredient such as flavors, colors, fats, oils, shortenings, emulsifiers, sugars, salt, vitamins, minerals, antioxidants, dietary fiber, soluble dietary fiber or water soluble fiber, such as resistant maltodextrin, digestion resistant maltodextrin, or maltodextrin (soluble dietary fiber), inulin, fructooligosaccharides, oat beta-glucans, and polydextrose, cellulose, and mixtures thereof. The process compatible ingredients may be employed in effective amounts which do not adverse affect sprayability or atomization of the aqueous solution, or the attainment of a thin, uniform coating of the water soluble film-forming coating, or which result in interparticle or equipment stickiness problems. The process compatible ingredients are preferably water soluble, and are dissolved in the aqueous coating solution. However, the process compatible ingredients may also be suspended in the aqueous coating solution, or be emulsified with the aqueous coating solution, for example as an oil-in-water emulsion.

The aqueous coating solution may thus serve as a carrier for all or portion of a process compatible ingredient and has been found to achieve various product benefits, such as enhanced flavor impact, shelf life, crunchiness, and freshness. For example, in embodiments where the edible core is nuts, the aqueous coating solution preferably contains an antioxidant, such as rosemary extract, BHA, BHT, TBHQ, vitamin E, or mixtures thereof, to achieve enhanced extended shelf-life, and/or salt to achieve enhanced flavor impact. When salt is first dissolved in the solution and then coated onto the nut, it provides a different flavor impact, compared to applying it in dry or particulate form. In embodiments of the invention, it has been found that optimum salt application on certain nut types, specifically almonds, occurs when about 40% by weight to about 60% by weight, preferably about 50% by weight of the total salt is dissolved in the solution and the other 50% is applied as a dry component. Also, not only do coated products exhibit an extended shelf life versus uncoated products, but when an antioxidant is dissolved in the aqueous solution, such as a maltodextrin solution and coated onto a nut, the shelf life is extended even more than when the antioxidant is used on its own. The combination of maltodextrin and rosemary extract exhibits a synergistic effect.

In embodiments of the invention, the amount of the at least one process compatible ingredient may range up to about 20% by weight, for example from about 1% by weight to about 10% by weight, based upon the weight of the aqueous coating solution.

One or more sugars may be optionally included in the aqueous coating solution to provide a sweet taste, and control texture of the snack. Sugars, particularly liquid sugars, tend to provide a crunchy, harder texture. The sugars employed may be mono- and/or di-saccharides, such as sucrose, fructose, lactose, dextrose, maltose, galactose, glucose syrup, invert syrup, high fructose corn syrup, molasses, brown sugar, maple syrup, mixtures thereof, and the like. The sugar may be admixed with the other ingredients in either solid or crystalline form, such as crystalline or granulated sucrose, granulated brown sugar, or crystalline fructose, or in liquid form, such as sucrose syrup or high fructose corn syrup. Use of solid or crystalline forms of sugars which may dissolved in the aqueous coating solution is preferred so as to more accurately control the composition of the coating formed on the edible core materials from batch to batch. Granulated sucrose is a preferred sugar for use in the production of sweet coated snacks. In embodiments of the present invention, snacks, such as savory snacks may be produced without the addition of a sugar. Exemplary amounts of sugars which may be employed in the production of the coated snacks may range up to about 20% by weight, for example from about 1% by weight to about 10% by weight, based upon the weight of the aqueous coating solution.

In embodiments of the present invention, an oleaginous composition may optionally be included in the aqueous coating solution by admixing to form an emulsion. Oleaginous compositions, which may be used may include any known edible shortening or fat blends or compositions, or oils, such as topping oils, and they may include conventional food-grade emulsifiers. The oleaginous compositions should preferably be in a liquid state at temperatures employed for the storage and application of the aqueous coating solution. Vegetable oils or plant oils, lard, marine oils, and mixtures thereof, which are fractionated, partially hydrogenated, and/or interesterified, are exemplary of the shortenings or fats which may be used in the present invention. Exemplary of the edible triglycerides which can be used to obtain the oleaginous compositions for use in the present invention include naturally occurring triglycerides derived from vegetable or plant sources such as soybean oil, palm kernel oil, palm oil, rapeseed oil, safflower oil, sesame oil, sunflower seed oil, peanut oil, cottonseed oil, and mixtures thereof. Marine and animal oils such as sardine oil, menhaden oil, babassu oil, lard, and tallow may also be used. Solid shortenings or fats in powdered form may be melted and emulsified with the aqueous coating solution. Cottonseed oil alone or in combination with peanut oil is preferred in embodiments of the present invention. Exemplary amounts of an oleaginous composition which may be used are up to about 20% by weight, for example from about 1% by weight to about 10% by weight, based upon the weight of the aqueous coating solution.

Edible emulsifiers which may be employed in the aqueous coating solutions of the present are exemplified by mono- and/or diglycerides, and derivatives thereof, such as acetylated mono- and/or diglycerides, diacetyl tartaric acid esters of mono- and/or diglycerides, succinylated mono- and/or diglycerides, ethoxylated/propoxylated mono- and/or diglycerides, lactylated mono- and/or diglycerides and citric acid esters of mono- and/or diglycerides), sorbate esters, sugar esters, polyglycerol esters, propylene glycol esters, lecithin, polysorbates, and combinations thereof. Lecithin is a preferred emulsifier for emulsification of an oleaginous composition with the aqueous coating solution. Exemplary amounts of the optional emulsifier which may be used are up to about 10% by weight, for example from about 0.05% by weight to about 5% by weight, based upon the weight of the aqueous coating solution.

The aqueous coating solution may optionally contain a leavening system or pH-adjusting agents to help control texture or taste of the coating. Exemplary of chemical leavening agents or pH-adjusting agents which may be used include alkaline materials and acidic materials such as sodium bicarbonate, ammonium bicarbonate, calcium acid phosphate, calcium phosphate (monobasic, monohydrate), sodium acid pyrophosphate, diammonium phosphate, tartaric acid, mixtures thereof, and the like. The optional leavening system or pH-adjusting agents may be employed in amounts up to about 1% by weight, for example up to about 0.1% by weight, based upon the weight of the aqueous coating solution.

In addition to the foregoing, the aqueous coating solution of the invention may include other additives conventionally employed on nuts, crackers and snacks which are process compatible. Such additives may include, for example, milk by-products, egg or egg by-products, cheese, cocoa, salt, honey, monosodium glutamate, vanilla or other flavorings, seasonings, or spices. For example, salt may be added to the aqueous coating solution in an amount of from about 1% by weight to about 4% by weight, for example from about 2% by weight to about 3% by weight, based upon the weight of the aqueous coating solution.

After the aqueous coating solution is applied to the tumbling edible cores and dried, and then cooled, conventional snack-flavoring, -seasoning, and -coloring ingredients, odorants, condiments, confections, and mixtures thereof may be applied upon the cooled, dry, coated edible core material. Exemplary of such ingredients which may be used include flavorings such as the savory flavors of barbecue, sour cream, chives, onion, garlic, butter, salt, vinegar, honey mustard, ranch, bacon, chicken, beef, cheese, and ham flavorings, the sweet flavors of cinnamon and sugar, peanut butter, banana nut, apple pie, honey graham, shortbread, butter toffee, cocoa crunch, chocolate chip, honey nut, oatmeal raisin, and vanilla crunch flavorings, cookie flavors, nuts and seeds, vanilla, and chocolate products, dried vegetable flakes and herb flakes such as pepper, basil, thyme, peppermint, dried tomato, and parsley flakes, condiment flakes, fruit flakes, spices, cheese powders such as cheddar cheese and Nacho cheese seasoning powders, and mixtures thereof.

The seasonings or flavorings may be applied by coating the cooled, dry, coated edible core material pieces with an oil-based binding composition, or topping oil, and then applying a powdered seasoning composition to the binder coated pieces. In preferred embodiments, cottonseed oil or a blend of cottonseed oil and peanut oil, preferably in a weight ratio of about 50:50, is preferably employed as an oil-based binding composition, glazing or seasoning oil, or topping oil. Use of an oil-based binding composition rather than a water-based binder avoids the need for subsequent drying to obtain a shelf-stable final snack product. In embodiments of the invention, the oil-based binding composition or oil slurry may be used in an amount of from about 2% by weight to about 8% by weight, preferably from about 4% by weight to about 6% by weight, based upon the total weight of the seasoned snack, when the snack is a fried snack. In baked varieties, the oil-based binding composition may be used in an amount up to about 20% by weight, preferably up to about 15% by weight, based upon the total weight of the seasoned snack. The powdered seasoning may be employed in an amount of from about 2% by weight to about 15% by weight, preferably from about 4% by weight to about 8% by weight, based upon the total weight of the seasoned snack.

In accordance with the method of the present invention, at the time of application of the aqueous coating solution to the edible core material, the cooked core material is at a temperature above the boiling point of the aqueous coating solution. For example, oil roasting temperatures may range from about 215° F. to about 400° F., preferably from about 250° F. to about 350° F. out of the roaster. In embodiments of the invention, dry roasting may be performed at dry roasting temperatures of from about 240° F. to about 330° F. Nut temperatures at the time of application of the aqueous coating solution may be within those ranges, and may be the same or substantially the same as the nut exit temperature from the roaster. In embodiments of the invention, the roasted nut temperature may be permitted to fall up to about 25% less, than the nut exit temperature, provided the remaining latent heat of the nut at the time of application of the aqueous coating solution is sufficient to reduce the moisture content of the aqueous solution of the film-forming coating solution to set or precipitate the film-forming component into a dry film without the need for additional drying by convection or forced air. Oil roasting or dry roasting times may range up to about 30 minutes, preferably from about 2 minutes to about 8 minutes.

In the case of baked goods, baking temperatures and times may range from about 215° F. to about 600° F. for about 2 minutes to about 25 minutes, preferably from about 275° F. to about 375° F. for about 2.5 minutes to about 15 minutes. Nut temperatures at the time of application of the aqueous coating solution may be within those ranges, and may be the same or substantially the same as the nut exit temperature from the roaster. In embodiments of the invention, the baked good temperature may be permitted to fall up to about 25% less, than the baked good oven exit temperature, provided the remaining latent heat of the baked good at the time of application of the aqueous coating solution is sufficient to reduce the moisture content of the aqueous solution of the film-forming coating solution to set or precipitate the film-forming component into a dry film without the need for additional drying by convection or forced air.

The cooked edible cores, such as roasted nuts, baked goods or snacks, extruded snacks, or ready-to-eat cereals which are subjected to the coating step may have a moisture content at the time of application of the aqueous coating solution of less than about 10% by weight, for example from about 0.25% by weight to about 7% by weight, preferably from about 1% by weight to about 5% by weight, based upon the weight of the cooked edible core, such as an oil roasted nut, a baked snack chip, a cracker, a cookie, or a ready-to-eat cereal.

The aqueous coating solution which is applied to the core material may be at any temperature, for example at room temperature or above, preferably at an elevated temperature, but which is below the boiling point of the aqueous coating solution. In embodiments of the invention, the aqueous coating solution may be applied at a temperature of at least about 150° F., but which is below the boiling point of the aqueous coating solution, for example an elevated temperature of from about 160° F. to about 212° F.

The dry coating may be formed on the tumbling edible core material by continuously supplying or spraying hot, aqueous coating solution during tumbling to apply the hot aqueous coating solution to the tumbling edible core material. In embodiments of the invention, the aqueous coating solution is applied by spray atomization nozzles to the edible core material within 10 minutes, for example within about 3 minutes, preferably within about 60 seconds, most preferably within about 30 seconds after the cooked product leaves the cooking apparatus, such as a roasting apparatus or fryer in the case of roasted nuts. Immediate transfer of the cooked edible core material to the tumbling apparatus may be achieved by gravity feed with chutes and/or by conveyers.

Application of the hot aqueous coating solution to the hot edible cores generates steam which may be vented or removed from the rotating tumbler without forced air drying. Also, application of the aqueous coating solution to the edible cores generally cools the core material to a temperature below the boiling point of water, for example to a temperature of from about 175° F. to about 210° F. The residence time of the edible cores, such as oil roasted nuts, in the coating apparatus may adjusted to achieve a desired weight percentage of the coating, based upon the total weight of the edible core and the dried coating. For example, the residence time of edible cores within a rotating coating drum may be adjusted by adjusting the tilt angle of the drum. Increasing the residence time tends to increase the thickness and gloss or shininess of the coating. In embodiments of the invention, the residence time of the edible cores within the coating apparatus may be less than about 2 minutes.

After application of the aqueous coating solution, the dried, coated core material may be cooled to obtain individual pieces having a core material coated or encased in a thin coating which has a crispy texture. Cooling temperatures and times may be used to control the degree of roasting and to prevent over-roasting of nuts or overcooking of other edible cores. If seasoning is applied to coated pieces, cooling the pieces to a temperature of about 90° F. to about 130° F., preferably from about 100° F. to about 120° F. provides better adhesion of the seasoning. After application of the seasoning, further cooling to ambient temperature may be performed to stop further roasting or cooking of the cores. Cooling times may range from about 2 minutes to about 10 minutes, preferably from about 4 minutes to about 6 minutes.

Conventional heating and cooling devices, such as conventional fryers, fryer/coolers, baking ovens, rotary coating drums or tumblers, spraying or atomizing equipment, and cooling equipment, may be employed in producing the coated products of the present invention. Fryers equipped with agitators, or stirring paddles may be employed for preventing sticking of individual cores to each other during frying. Also, fryers equipped with product submersion means may employed in embodiments of the invention. In embodiments of the invention, a HeatWave® fryer manufactured by Heat and Control, Inc. Hayward, Calif., which allows the cores, such as nuts to pass under and/or through curtains of oil instead of being submerged in oil may be employed. The tumbling may be performed in conventional tumbling bed coating equipment, such as pan coaters, revolving pans, or rotating drums. However, in a preferred embodiment, tumbling and coating formation is performed in a continues rotating drum or tumbler which is equipped with a spraying device having one or more atomizing nozzles.

The latent heat from the cooked edible core material reduces the moisture content of the aqueous solution so as to obtain a coated food product having a microbially shelf-stable moisture content of less than about 10% by weight, for example from about 0.5% by weight to about 8% by weight, preferably from about 2% by weight to about 5% by weight, based upon the total weight of the edible core and the dried coating. The snack products of the present invention may be packaged in polyethylene foil lined bags with a nitrogen flush, or in glass or plastic jars, or composite cans. In embodiments of the invention, the snack products may be vacuum packed or nitrogen flushed. The products may exhibit an extended shelf life of at least about 12 months, preferably at least about 24 months, depending upon packaging materials and methods.

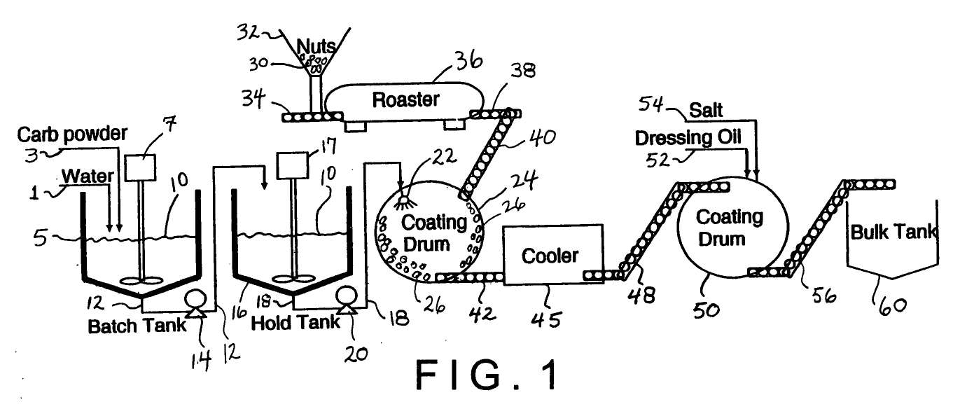

In a method and apparatus for making a coated fried snack, such as coated, oil roasted nuts, as shown in FIG. 1, dry coating ingredients such as a water-soluble, film-forming coating component, for example a carbohydrate powder such as maltodextrin 1 are admixed with water 3 in a jacketed heating vessel or batch tank 5 equipped with a mixing device 7 at an elevated temperature to form an aqueous solution 10 of the film-forming coating component in the water. The heated aqueous solution 10 may be transported via piping 12 and a pump 14 to a second jacketed heating vessel or holding tank 16 equipped with a mixing device 17 for further mixing and heating to maintain a desired elevated temperature for the aqueous solution 10.

The heated aqueous solution 10 may be continuously fed via piping 18 and a pump 20 to one or more spray atomization nozzles 22 located within a first coating drum 24 for spraying the aqueous solution onto oil roasted nuts 26 as they are tumbled within the rotating first coating drum 24.

The oil roasted nuts 26 may be obtained by feeding raw nuts 30 from a feed hopper 32 onto a roaster inlet conveyor 34, which feeds the raw nuts 30 into a conventional nut oil roaster 36. The roasted nuts exit the roaster 36 on a roaster outlet conveyor 38 and while still hot are continuously fed from the roaster 36 and outlet conveyor 38 onto a gravity chute feeder or conveyor 40 into the inlet end of the first coating drum 24.

The coating drum 24 may be inclined and equipped with ribs for tumbling the nuts as they are transported by gravity from the inlet end to the outlet end of the coating drum 24. The oil roasted nuts 26 are continuously tumbled and sprayed with the aqueous solution 10 which is atomized by the nozzles 22 as the roasted nuts 26 are transported through the rotating drum 24. The nuts 26 are cooled by evaporative cooling from the aqueous solution 10 as the water turns to steam from the latent heat of the roasted nuts 26 and the water soluble film forming coating component precipitates from solution or dries or sets to form a thin, dry film on the roasted nuts 26 in the coating drum 24.

The resulting individual, free-flowing dry, coated nuts may be dropped onto a coating drum outlet conveyor 42 and transported to a cooler or cooling device 45, which may include a meshed conveying belt and a blower for blowing cool air across the belt.

The cooled product may then be transported by a cooler outlet conveyor 48 and fed into a conventional seasoning drum or second coating drum 50. A dressing or seasoning oil 52 and a dry powdered seasoning, such as salt 54 may also be fed to seasoning drum 50 for application to the cooled, coated nuts as they are tumbled and transported through the drum 50. The seasoned, coated nuts may then be transported and fed by a seasoning drum outlet conveyor 56 to a bulk storage tank 60 for storage before being transported to packaging equipment.

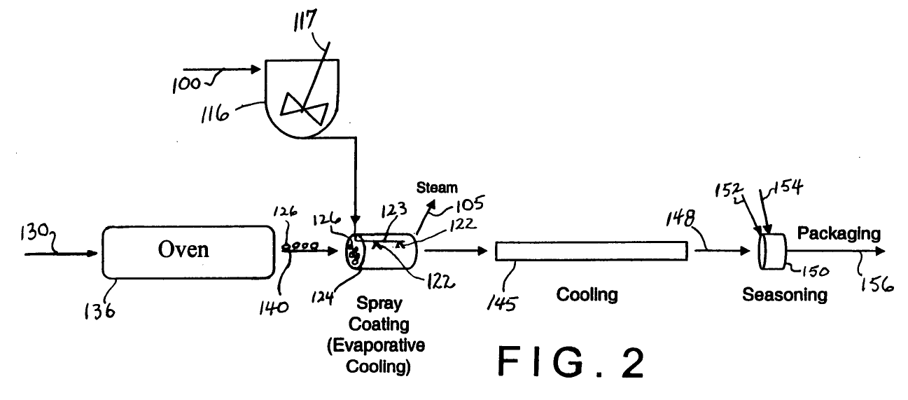

In a method and apparatus for making a coated baked snack, such as coated crackers or coated fabricated baked chips, as shown in FIG. 2, an aqueous solution 100 of a film-forming coating component, such as maltodextrin dissolved in water may be fed to a jacketed heating vessel or holding tank 116 equipped with a mixing device 117 for mixing and heating to maintain a desired elevated temperature for the aqueous solution 100.

The heated aqueous solution 100 may be continuously fed to one or more spray atomization nozzles 122 located within a first coating drum 124 for spraying the aqueous solution onto baked snack pieces 126 as they are tumbled within the rotating first coating drum 124.

The baked snack pieces 126 may be obtained by feeding dough pieces 130 from a conventional dough sheet cutting operation (not shown) into a conventional multizone baking oven 136 equipped with a belt conveyor for transporting the pieces through the oven zones. The baked pieces, such as crackers or fabricated chips 126 exit the oven 136 on the oven band and while still hot may be continuously fed from the oven 136 onto a gravity chute feeder or conveyor 140 into the inlet end of the first coating drum 124.

The coating drum 124 may be inclined and equipped with ribs for tumbling the baked snacks as they are transported by gravity from the inlet end to the outlet end of the coating drum 124. The baked snacks 126 are continuously tumbled and sprayed with the aqueous solution 110 which is atomized by the nozzles 122 as the baked snacks 126 are transported through the rotating drum 124. The baked snacks 126 are cooled by evaporative cooling from the aqueous solution 100 as the water turns to steam 105 from the latent heat of the baked snacks 126 and the water soluble film forming coating component precipitates from solution or dries or sets to form a thin, dry film on the baked snack pieces 126 in the coating drum 124.

The resulting individual, free-flowing dry, coated baked snack pieces may be conveyed on a conveyor 142 to a cooler or cooling device 145, which may include a meshed conveying belt and a blower for blowing cool air across the belt.

The cooled product may then be transported by a cooler outlet conveyor 148 and fed into a conventional seasoning drum or second coating drum 150. A dressing or seasoning oil 152 and a dry powdered seasoning, such as salt 154 may also be fed to seasoning drum 150 for application to the cooled, coated baked snack pieces as they are tumbled and transported through the drum 150. The seasoned, coated baked snack pieces may then be transported and fed by a seasoning drum outlet conveyor 156 to packaging equipment.

As shown in FIG. 2 the aqueous solution 100 may be applied to the tumbling core material 126 via a plurality of spray nozzles 122 from pipe 123, which may be parallel to, positioned above, and offset from the central longitudinal axis of the rotating drum 124. The spray nozzles 122 may be oriented at an angle to direct the spray towards a particular inner peripheral section of the drum.

Pipe 123 may be a conventional spraying device equipped with nozzles 122. Conventional spray devices which may be used include airless and air-assisted airless spray devices and electrostatic spray devices. In preferred embodiments, the spray nozzles 122 provide atomization of the aqueous solution. In addition, in embodiments of the invention, each atomizing nozzle 122 may provide a conical spray pattern or a flat spray pattern. The sprays from each nozzle 122 may combine into a substantially continuous longitudinal spray that descends upon the tumbling core material 126 to provide substantially uniform coating of the pieces 126. In other embodiments, the individual sprays may descend upon the pieces 126 with gaps between the sprays. The plurality of atomizing nozzles 122 may be equally spaced along the length of pipe 123. Generally, two or more atomizing nozzles 122 are spaced along pipe 123 for providing a continuous spray.

The following examples, wherein all parts, percentages, and ratios are by weight, all temperatures are in ° F., and all pressures are atmospheric unless indicated to the contrary, illustrate the present invention:

### EXAMPLE 1

The ingredients and their relative amounts which may be used for making coated in oil roasted almonds in accordance with the present invention are shown in Table 3:

TABLE 3
Coated Oil Roasted Almonds

| | | Formula Amount, |
|---|---|---|
| Ingredient | Amount, parts by wt. | parts by weight |
| Raw Almonds | | 100 |
| Aqueous Coating Solution | | 7 |
| Maltodextrin Powder | 50 | |
| Water | 50 | |
| | 100 | |
| Seasoning | | |
| Topping Oil | | 5 |
| Salt | | 1 |

Oil roasted almonds coated with a maltodextrin film may be produced in accordance with the present invention by preparing an aqueous coating solution of maltodextrin and spraying the coating solution upon the hot oil roasted nuts.

The aqueous coating solution may be prepared by admixing 50 parts by weight of maltodextrin with 50 parts by weight of heated water to dissolve the maltodextrin in the water. The resulting aqueous solution may be transferred to a heated holding tank where it is maintained at a temperature of about 150° F. for application to the roasted nuts.

Raw almonds, having a moisture content of about 8% by weight to about 10% by weight, may be roasted in cottonseed oil maintained at a temperature of about 310° F. The roaster may be equipped with a main conveyor and a submerger conveyor. The average residence time of the nuts in the hot oil may be about 2 minutes and 45 seconds. After emerging from the hot oil, the nuts may be immediately transferred at a nut temperature of about 260° F. to a rotating coating drum equipped with atomizing spray nozzles. The time lapse from the time the nuts exit the roaster to the time they enter the rotating drum may be less than about 30 seconds. The raw nuts may pick up about 1% by weight to about 6% by weight of oil during roasting and may have their moisture content reduced to about 1.97% by weight. The feed rate of the oil roasted nuts to the coating drum may be about 5000 lbs/hr.

The aqueous coating solution may be continuously fed to the spray atomization nozzles at a rate of about 350 lbs/hr to coat the hot, roasted almonds with the aqueous coating solution, thereby forming a thin film of maltodextrin on the almonds within the coating drum. After coating the roasted almonds, the coated almonds may have a moisture content of about 2.51% by weight, and a maltodextrin coating content of about 3.5% by weight, based upon the weight of the coated almonds.

The coated almonds exiting the coating drum may have a temperature of about 200° F. as a result of evaporative cooling within the coating drum. The coated almonds may then be cooled to about 110° F. using a series of cooling conveyors where ambient air is passed through a mesh cooling belt carrying the coated almonds, to obtain individual almonds, each coated with a thin, uniform coating that has a crispy texture.

After cooling, a topping oil which is a blend of cottonseed oil and peanut oil in a weight ratio of about 50:50 may be applied at a rate of about 250 lb/hr, and salt may be applied at a rate of about 50 lbs/hr to the almonds in a seasoning drum. The seasoned almonds may then be packaged in conventional manner.

### EXAMPLE 2

The ingredients and their relative amounts which may be used for making coated oil roasted almonds in accordance with the present invention are shown in Table 4:

TABLE 4
Coated Oil Roasted Almonds

| | | Formula Amount, |
|---|---|---|
| Ingredient | Amount, parts by wt. | parts by weight |
| Raw Almonds | | 100 |
| Aqueous Coating Solution | | 5.5 |
| Maltodextrin Powder | 50 | |
| Water | 50 | |
| | 100 | |
| Seasoning | | |
| Topping Oil | | 4 |
| Salt | | 1 |

Oil roasted almonds coated with a maltodextrin film may be produced in accordance with the present invention by preparing an aqueous coating solution of maltodextrin and spraying the coating solution upon the hot oil roasted nuts.

The aqueous coating solution may be prepared by admixing 50 parts by weight of maltodextrin with 50 parts by weight of heated water to dissolve the maltodextrin in the water. The resulting aqueous solution may be transferred to a heated holding tank where it is maintained at a temperature of about 150° F. for application to the roasted nuts.

Raw almonds, having a moisture content of about 8% by weight to about 10% by weight, may be roasted in cottonseed oil maintained at a temperature of about 295° F. The roaster may be equipped with a main conveyor and a submerger conveyor. The average residence time of the nuts in the hot oil may be about 3 minutes and 40 seconds. After emerging from the hot oil, the nuts may be immediately transferred at a nut temperature of about 260° F. to a rotating coating drum equipped with atomizing spray nozzles. The time lapse from the time the nuts exit the roaster to the time they enter the rotating drum may be less than about 30 seconds. The raw nuts may pick up about 1% by weight to about 6% by weight of oil during roasting and may have their moisture content reduced to about 1.87% by weight. The feed rate of the oil roasted nuts to the coating drum may be about 22.64 lbs/min.

The aqueous coating solution may be continuously fed to the spray atomization nozzles at a rate of about 564 g/min to coat the hot, roasted almonds with the aqueous coating solution, thereby forming a thin film of maltodextrin on the almonds within the coating drum. After coating the roasted almonds, the coated almonds may have a moisture content of about 2.55% by weight, and a maltodextrin coating content of about 2.75% by weight, based upon the weight of the coated almonds.

The coated almonds exiting the coating drum may have a temperature of about 210° F. as a result of evaporative cooling within the coating drum. The coated almonds may then be cooled to a temperature of about 170° F. using an inclined conveyor and then cooled to a temperature of about 115° F. using another cooling conveyor where ambient air is passed through a mesh cooling belt carrying the coated almonds, to obtain individual almonds, each coated with a thin, uniform coating that has a crispy texture.

After cooling, a topping oil which is a blend of cottonseed oil and peanut oil in weight ratio of about 50:50 may be applied at a rate of about 410 g/min, and salt may be applied at a rate of about 102.5 g/min to the almonds in a seasoning drum. The seasoned almonds may then be packaged in conventional manner.

### EXAMPLE 3

The ingredients and their relative amounts which may be used for making coated oil roasted cashews in accordance with the present invention are shown in Table 5:

TABLE 5
Coated Oil Roasted Cashews

| | | Formula Amount, |
|---|---|---|
| Ingredient | Amount, parts by wt. | parts by weight |
| Raw Cashews | | 100 |
| Aqueous Coating Solution | | 5.5 |
| Maltodextrin Powder | 50 | |
| Water | 50 | |
| | 100 | |
| Seasoning | | |
| Topping Oil | | 2.4 |
| Salt | | 1 |

Oil roasted cashews coated with a maltodextrin film may be produced in accordance with the present invention by preparing an aqueous coating solution of maltodextrin and spraying the coating solution upon the hot oil roasted nuts.

The aqueous coating solution may be prepared by admixing 50 parts by weight of maltodextrin with 50 parts by weight of heated water to dissolve the maltodextrin in the water. The resulting aqueous solution may be transferred to a heated holding tank where it is maintained at a temperature of about 150° F. for application to the roasted nuts.

Raw cashews, having a moisture content of about 8% by weight to about 10% by weight, may be roasted in cottonseed oil maintained at a temperature of about 295° F. The roaster may be equipped with a main conveyor and a submerger conveyor. The average residence time of the nuts in the hot oil may be about 3 minutes and 40 seconds. After emerging from the hot oil, the nuts may be immediately transferred at a nut temperature of about 260° F. to a rotating coating drum equipped with atomizing spray nozzles. The time lapse from the time the nuts exit the roaster to the time they enter the rotating drum may be less than about 30 seconds. The raw nuts may pick up about 1% by weight to about 6% by weight of oil during roasting and may have their moisture content reduced to about 1.56% by weight. The feed rate of the oil roasted nuts to the coating drum may be about 22.0 lbs/min.

The aqueous coating solution may be continuously fed to the spray atomization nozzles at a rate of about 498 g/min to coat the hot, roasted cashews with the aqueous coating solution, thereby forming a thin film of maltodextrin on the cashews within the coating drum. After coating the roasted cashews, the coated cashews may have a moisture content of about 2.21% by weight, and a maltodextrin coating content of about 2.75% by weight, based upon the weight of the coated cashews.

The coated cashews exiting the coating drum may have a temperature of about 210° F. as a result of evaporative cooling within the coating drum. The coated cashews may then be cooled to a temperature of about 170° F. using an inclined conveyor and then cooled to a temperature of about 115° F. using another cooling conveyor where ambient air is passed through a mesh cooling belt carrying the coated cashews, to obtain individual cashews, each coated with a thin, uniform coating that has a crispy texture.

After cooling, a topping oil which is a blend of cottonseed oil and peanut oil in a weight ratio of about 50:50 may be applied at a rate of about 217 g/min, and salt may be applied at a rate of about 91 g/min to the cashews in a seasoning drum. The cashews may then be packaged in conventional manner.

### EXAMPLE 4

Coated oil roasted almonds in accordance with the present invention may be produced as in Example 2 except: a) 50% by weight of the seasoning salt may be dissolved in the aqueous coating solution, and b) water dispersible rosemary extract (96% by weight natural rosemary oil extract and 4% by weight carrier) may be homogeneously dispersed in the aqueous coating solution in amounts ranging from about 200 ppm to about 1100 ppm, based upon the weight of the aqueous coating solution.

### EXAMPLE 5

Coated dry roasted almonds in accordance with the present invention may be produced as in Example 2 except the raw almonds may be dry roasted in conventional dry roasting equipment at a temperature of about 312° F. After emerging from the dry roaster, the nuts may be immediately transferred at a nut temperature of about 280° F. to a rotating coating drum equipped with atomizing spray nozzles. The time lapse from the time the nuts exit the roaster to the time they enter the rotating drum may be less than about 30 seconds. During roasting, the raw nuts do not pick up any oil and may have their moisture content reduced to about 1.87% by weight.

What is claimed is:

1. A method for making a coated food product comprising cooking an edible core material to obtain a cooked edible core material, tumbling the cooked edible core material, spraying an aqueous solution comprising a water-soluble, film-forming coating component onto the cooked edible core material while tumbling the cooked edible core material to coat the cooked edible core material with said aqueous solution, said tumbling and spraying being performed immediately after said cooking of the edible core material so that latent heat from the cooked edible core material flashes off moisture from the aqueous solution to reduce the moisture content of the aqueous solution on the cooked edible core material and form a dry coating of the coating component on the cooked edible core material, and cooling the dry, coated cooked edible core material.

2. A method for making a coated food product as claimed in claim 1 wherein said edible core material is a member selected from the group consisting of nuts, whole grains, dried fruits, dried vegetables, cookies, crackers, ready-to-eat cereals, and confectionary chips.

3. A method for making a coated food product as claimed in claim 1 wherein said cooking is by frying, and the cooked edible core material subjected to said spraying has a temperature above the boiling point of said aqueous solution.

4. A method for making a coated food product as claimed in claim 1 wherein said edible core material comprises nuts.

5. A method for making a coated food product as claimed in claim 1 wherein the moisture content of said aqueous solution which is sprayed onto the tumbling edible core material is from about 25% by weight to about 75% by weight, based upon the weight of the aqueous solution, and said latent heat from the cooked edible core material reduces the moisture content of the aqueous solution so as to obtain a coated food product having a moisture content of less than about 10% by weight, based upon the total weight of the edible core and the dried coating.

6. A method for making a coated food product as claimed in claim 1 wherein said cooking is by oil roasting and said edible core material comprises nuts.

7. A method for making a coated food product as claimed in claim 6 wherein the oil roasted nuts subjected to said spraying have a temperature of from about 215° F. to about 400° F. and a moisture content of less than about 10% by weight, based upon the weight of the roasted nut, and said aqueous solution which is sprayed onto the tumbling nuts has a temperature of at least about 150° F. but less than the boiling point of the aqueous solution.

8. A method for making a coated food product as claimed in claim 7 wherein the moisture content of said aqueous solution which is sprayed onto the tumbling edible core material is from about 25% by weight to about 75% by weight, based upon the weight of the aqueous solution, and said latent heat from the cooked edible core material reduces the moisture content of the aqueous solution so as to obtain a coated food product having a moisture content of less than about 10% by weight, based upon the total weight of the edible core and the dried coating.

9. A method for making a coated food product as claimed in claim 1 wherein said coating component is a carbohydrate.

10. A method for making a coated food product as claimed in claim 9 wherein said carbohydrate is a polysaccharide.

11. A method for making a coated food product as claimed in claim 10 wherein said polysaccharide comprises at least one member selected from the group consisting of starches, corn syrup solids, maltodextrins, and cellulose derivatives.

12. A method for making a coated food product as claimed in claim 1 wherein said coating component comprises a maltodextrin in an amount of from about 25% by weight to about 75% by weight, based upon the weight of the aqueous solution which is sprayed onto the tumbling edible core material.

13. A method for making a coated food product as claimed in claim 8 wherein said coating component comprises a maltodextrin in an amount of from about 25% by weight to about 75% by weight, based upon the weight of the aqueous solution which is sprayed onto the tumbling edible core material.

14. A method for making a coated food product as claimed in claim 1 wherein said coating component comprises at least one cellulose ether selected from the group consisting of methyl cellulose, ethylmethyl cellulose, carboxymethyl cellulose, hydroxypropyl cellulose, and hydroxypropylmethyl cellulose.

15. A method for making a coated food product as claimed in claim 1 wherein said film-forming coating component is selected from the group consisting of carbohydrates and proteins, and said aqueous solution further comprises at least one process compatible ingredient selected from the group consisting of flavors, colors, fats, oils, shortenings, emulsifiers, salt, vitamins, minerals, soluble fiber, and antioxidants.

16. A method for making a coated food product as claimed in claim 1 wherein the edible core material comprises nuts selected from the group consisting of almonds, cashews, peanuts, walnuts, pistachios, pine nuts, macadamia nuts, hazelnuts, Brazil nuts, and pecans.

17. A method for making a coated food product as claimed in claim 1 wherein said spraying comprises atomization with air.

18. A method for making a coated food product as claimed in claim 1 wherein said latent heat from the cooked edible core material reduces the moisture content of the aqueous solution so as to obtain a coated food product having a moisture content of less than about 10% by weight, and a coating component content on the edible core material of from about 0.5% by weight to about 20% by weight, each percentage being based upon the total weight of the edible core and the dried coating.

19. A method for making a coated food product as claimed in claim 7 wherein said aqueous solution which is sprayed onto the tumbling edible core material further comprises salt and an antioxidant.

20. A method for the continuous production of coated nuts comprising oil roasting nuts in an oil roaster to obtain roasted nuts, continuously transferring the roasted nuts into a continuous rotary tumbler, continuously spraying the roasted nuts as they are tumbled in the rotary tumbler with an aqueous solution comprising a film-forming coating component to coat the tumbling roasted nuts with said aqueous solution, said tumbling and spraying being performed immediately after said roasting of the nuts so that latent heat from the roasted nuts flashes off moisture from the aqueous solution to reduce the moisture content of the aqueous solution on the roasted, tumbling nuts and form a dry coating of the coating component on the roasted nuts, and cooling the dry, coated roasted nuts.

21. A method for the continuous production of coated nuts as claimed in claim 20 wherein said coating component comprises a maltodextrin.

22. Apparatus for the continuous production of coated nuts comprising an oil roaster for oil roasting nuts, a continuous rotary tumbler for continuously receiving and tumbling roasted nuts from said oil roaster, said rotary tumbler being equipped with spraying apparatus for continuously spraying the roasted nuts as they are tumbled in the rotary tumbler with an aqueous solution comprising a film-forming coating component to coat the tumbling nuts with said aqueous solution, said rotary tumbler and said oil roaster being arranged so that said tumbling and spraying are performed immediately after the roasted nuts exit said oil roaster so that latent heat from the roasted nuts flashes off moisture from the aqueous solution to reduce the moisture content of the aqueous solution on the roasted, tumbling nuts and form a dry coating of the coating component on the roasted nuts, and a cooling device for cooling the dry, coated roasted nuts.

23. Apparatus for the continuous production of coated nuts as claimed in claim 22 wherein the oil roaster and the rotary tumbler are arranged so that the roasted nuts are gravity fed directly from the roaster to the rotary tumbler, the spraying apparatus comprises air atomization nozzles for atomizing the aqueous solution, and the cooling device comprises a meshed conveying belt and a blower for blowing cool air across the belt.

24. A coated, oil roasted nut obtained by the method of claim 21.
